(19) United States
(12) Patent Application Publication
(10) Pub. No.: US 2024/0256900 A1
(43) Pub. Date: Aug. 1, 2024

(54) METHOD FOR BUILDING BLOCKCHAIN-BASED SECURE AGGREGATION IN FEDERATED LEARNING WITH DATA REMOVAL

(71) Applicant: Jinan University, Guangzhou (CN)

(72) Inventors: Jiasi WENG, Guangzhou (CN); Yongdong WU, Guangzhou (CN); Jian WENG, Guangzhou (CN); Ming LI, Guangzhou (CN); Jianan LIU, Guangzhou (CN); Anjia YANG, Guangzhou (CN); Yejian LIANG, Guangzhou (CN)

(21) Appl. No.: 18/613,006

(22) Filed: Mar. 21, 2024

Related U.S. Application Data
(60) Provisional application No. 63/593,847, filed on Oct. 27, 2023.

(51) Int. Cl. G06N 3/098

(52) U.S. Cl. CPC G06N 3/098

(57) ABSTRACT

Method, device and system for building blockchain-based secure aggregation in federated learning with data removal are provided. The method includes: selecting a first quantity of client nodes, to participate in an i-th iteration; sending a list of the selected client nodes to each of the first quantity of client nodes; acquiring model training information transmitted by each of a second quantity of client nodes, the model training information being transmitted in a form of cypher text, where the cypher text is generated by performing homomorphic encryption on the model training information based on pairwise seeds computed for each of the first quantity of client nodes from a symmetric bivariate polynomial and a private seed computed from asymmetric bivariate polynomial; aggregating the cypher text to obtain an aggregate result; and broadcasting a list of the second quantity of client nodes and the aggregate result via a blockchain.

### CROSS-REFERENCE TO RELATED APPLICATIONS

This application claims the benefit of priority from U.S. Provisional Application No. 63/593,847, filed on Oct. 27, 2023. The content of the aforementioned application, including any intervening amendments thereto, is incorporated herein by reference in its entirety.

### FIELD

This disclosure is related to the technical field of machine learning, and in particular, to method, device and system for building blockchain-based secure aggregation in federated learning with data removal.

### BACKGROUND

Over the past few years, Blockchain has drawn significant attention from both academy and industry. Blockchain is a novel paradigm where distrustful parties make transactions and manage data without involving a trustworthy third-party. Blockchain achieves tamper-resistance and traceability for the transactions, offering anonymity and decentralization for the parties. Due to these features, Blockchain can be applied to a wide spectrum of applications, such as cryptocurrency, financial services, crowd-sourcing systems, Vehicular Ad Hoc Networks (VANETs) or the like.

Federated learning (FL), also known as collaborative learning, is a machine learning technique that trains an algorithm via multiple independent sessions, each using its own dataset. This approach stands in contrast to traditional centralized machine learning techniques where local datasets are merged into one training session, as well as to approaches that assume that local data samples are identically distributed. Federated learning addresses critical issues such as data privacy, data security, data access rights and access to heterogeneous data. Its applications engage industries including defense, telecommunications, Internet of Things, and pharmaceuticals.

Blockchain-based federated learning provides a potential approach to addressing these critical issues in connection with the federated learning, due to the characteristics of the blockchain. However, FL's evolving landscape introduces fresh challenges, such as the “Right to be Forgotten” (RTBF). The privacy and security problems in the scenario of RTBF have not been adequately considered. Therefore, there's need for new approaches for the Blockchain-based federated learning.

### SUMMARY OF THE INVENTION

In a first aspect of the disclosure, there is provided a method for building blockchain-based secure aggregation in federated learning with data removal, applied by a server in a system for building blockchain-based secure aggregation in federated learning with data removal, comprising:
selecting, from a plurality of client nodes each being provided with a unique identifier id in the system, a first quantity of client nodes, to participate in an i-th iteration of the federated learning, where i is an integer;
sending a list of the selected client nodes to each of the first quantity of client nodes;
acquiring model training information transmitted by each of a second quantity of client nodes among the first quantity of client nodes, the model training information being transmitted in a form of cypher text, and being obtained by the client nodes through training local models with local training data, wherein the cypher text is generated by performing homomorphic encryption on the model training information based on pairwise seeds computed for each of the first quantity of client nodes from a symmetric bivariate polynomial and a private seed computed from asymmetric bivariate polynomial;
aggregating the cypher text of the model training information to obtain an aggregate result; and
broadcasting a list of the second quantity of client nodes and the aggregate result via a blockchain.

In an implementation, the method further comprises: for a (i+1)-th iteration, sending a list of a third quantity of client nodes together with an aggregate result of model training information previously transmitted from the second quantity of client nodes, to each of the third quantity of client nodes, for allowing the third quantity of client nodes to reconstruct local models to be used in the (i+1)-th iteration, wherein the third quantity of client nodes are a subset of the second quantity of client nodes.

In an implementation, the symmetric bivariate polynomial denoted by F(x, y) and the asymmetric bivariate polynomial denoted by G(x, y) are selected and sent to the client nodes by a one-time dealer in an initialization process.

In an implementation, for any client node id, the pairwise seed computed for another client node with identifier id′ from the symmetric bivariate polynomial is f_{id}¹(id′)=F(id, id′), where F(id, id′)=F(id′, id).

In an implementation, the cypher text c_{id} generated by the client node id is generated by:

$${c}_{id} ← {x}_{id} + {\sum }_{id ′ ∈ {U}_{1} ∖ i d} Δ \cdot PRG ( {f}_{i d}^{1} ( {id}^{′} ) ) + PRG ( {g}_{i d}^{2} ( 0 ) ‖ 1 ) ( mod p )$$

$$where$$

$$Δ = \{ \begin{matrix}1 if id < {id}^{′} \\ - 1 if id > {id}^{′}\end{matrix}$$

wherein x_{id} represents the model training information obtained by the client node id, U₁ represents a set of identities of the first quantity of client nodes, PRG represents a Pseudo-Random Generator, g_{id}²(0) represents the private seed computed from the asymmetric bivariate polynomial G(0, id), p represents a roughly λ-bit prime, and λ is a security parameter.

In an implementation, the method further comprises:
acquiring the cipher text cid and a tag tagid transmitted by each of the second quantity of client nodes, wherein the cipher text cid and the tag tagid are computed by MaskAndMAC(pp, sk, id, xid)→(cid, tagid), wherein pp represents a public parameter component available to the server and the client nodes, sk represents secret key secretly shared among the client nodes, and xid represents the model training information of the client node id;
aggregating respective tags into an aggregate tag; and
broadcasting the aggregate tag associated with the aggregate result via the blockchain.

In a second aspect of the present disclosure, there is provided a method for building blockchain-based secure aggregation in federated learning with data removal, applied by a first client node in a system for building blockchain-based secure aggregation in federated learning with data removal, comprising:
receiving, from a server in the system, a list of selected client nodes, wherein the selected client nodes are in a first quantity and are selected to participate in an i-th iteration of the federated learning by the server from a plurality of client nodes in the system, each of the selected client nodes is provided with a unique identifier id, and the first client node is one of the first quantity of the selected client nodes, i is an integer;
acquiring model training information by training a local model with local training data;
generating cypher text of the model training information by performing homomorphic encryption on the model training information based on pairwise seeds computed for each of the first quantity of client nodes from a symmetric bivariate polynomial and a private seed computed from asymmetric bivariate polynomial; and
sending the cypher text of the model training information to the server.

In an implementation, the symmetric bivariate polynomial F(x, y) and the asymmetric bivariate polynomial G(x, y) are selected and sent to the client nodes by a one-time dealer in an initialization process.

In an implementation, the method further comprises:
computing, for the identifier id of the first client node, the cipher text cid and a tag tagid by MaskAndMAC (pp, sk, id, xid)→(cid, tagid), wherein pp represents a public parameter component available to the server and the client nodes, sk represents secret key secretly shared among the client nodes, and xid represents the model training information of the first client node id;
sending the cipher text cid and the tag tagid to the server.

In an implementation, for the first client node id, the pairwise seed computed for another client node with identifier id′ from the symmetric bivariate polynomial is f_{id}¹(id′)=F(id, id′), where F(id, id′)=F(id′, id).

In an implementation, the cypher text c_{id} generated by the client node id is generated by:

$${c}_{id} ← {x}_{id} + {\sum }_{id ′ ∈ {U}_{1} ∖ i d} Δ \cdot PRG ( {f}_{i d}^{1} ( {id}^{′} ) ) + PRG ( {g}_{i d}^{2} ( 0 ) ‖ 1 ) ( mod p )$$

$$where$$

$$Δ = \{ \begin{matrix}1 if id < {id}^{′} \\ - 1 if id > {id}^{′}\end{matrix}$$

wherein x_{id} represents the model training information obtained by the client node id, U₁ represents a set of identities of the first quantity of client nodes, PRG represents a Pseudo-Random Generator, g_{id}²(0) represents the private seed computed from the asymmetric bivariate polynomial G(0, id), p represents a roughly λ-bit prime, and λ is a security parameter.

In an implementation, the method further comprises:
for an (i+1)-th iteration:
acquiring, from the server, a list of a third quantity of client nodes together with an aggregate result of model training information previously transmitted from the second quantity of client nodes; and
reconstructing a local model to be used in the (i+1)-th iteration by using the list of the third quantity of client nodes together with the aggregate result of model training information previously transmitted from the second quantity of client nodes.

In an implementation, the reconstructing the local model to be used in the (i+1)-th iteration comprises:
computing private seeds (g_{id}¹(id′), g_{id}²(id′)), for each of the third quantity of client nodes, which is of identifier id′, wherein g_{id}¹(id′)=G(id, id′), g_{id}²(id′)=G(id′, id), id′∈U₃\id, U₃ represents a set of the identifiers of the third quantity of client nodes;
transmitting Lagrange Components of shares {g_{id}², (id)·L_{id′}}_{id′∈U}_{₂} for recovering each g_{id}²,(0) and corresponding shares for {f_{id′}²(id″)}_{id″∈U}_{₂}_{\U}_{₃}_{∧id″∈U}_{₁}_{\U}_{₂} via one-time encryption with previous pairwise shared keys, wherein L_{id′} represents Lagrange Component, U₁ represents a set of the identifiers of the first quantity of client nodes, and U₂ represents a set of the identifiers of the second quantity of client nodes;
reconstructing the local model using the shares above from id′∈U₃.

In an implementation, the method further comprises:
acquiring, from the block-chain, an aggregate tag associated with the aggregate result of model training information previously transmitted from the third quantity of client nodes, and
before reconstructing the local model, verifying correctness of the aggregate result by checking validity of the aggregate tag against the aggregate result,
wherein the aggregate tag is aggregated by the server from tags of the client nodes.

In a third aspect of the present disclosure, there is provided a system for building blockchain-based secure aggregation in federated learning with data removal, comprising a server, a plurality of client nodes, and a block chain, wherein:
the server is configured for:
   selecting, from the plurality of client nodes each being provided with a unique identifier id in the system, a first quantity of client nodes, to participate in an i-th iteration of the federated learning, where i is an integer;
   sending a list of the selected client nodes to each of the first quantity of client nodes;
   acquiring model training information transmitted by each of a second quantity of client nodes among the first quantity of client nodes, the model training information being transmitted in a form of cypher text;
   aggregating the cypher text of the model training information to obtain an aggregate result; and
   broadcasting a list of the second quantity of client nodes and the aggregate result via the blockchain; and
each of the plurality of client nodes is configured for:
   receiving, from a server in the system, the list of selected first quantity client nodes;
   acquiring model training information by training a local model with local training data;
   generating cypher text of the model training information by performing homomorphic encryption on the model training information based on pairwise seeds computed for each of the first quantity of client nodes from a symmetric bivariate polynomial and a private seed computed from asymmetric bivariate polynomial; and
   sending the cypher text of the model training information to the server.

In an implementation, the symmetric bivariate polynomial is F(x, y) and the asymmetric bivariate polynomial is G(x, y), the pairwise seed computed for another client node with identifier id′ from the symmetric bivariate polynomial is f_{id}¹(id′)=F(id, id′), where F(id, id′)=F(id′, id), the cypher text c_{id} generated by the client node id is generated by:

$${c}_{id} ← {x}_{id} + {\sum }_{id ′ ∈ {U}_{1} ∖ i d} Δ \cdot PRG ( {f}_{i d}^{1} ( {id}^{′} ) ) + PRG ( {g}_{i d}^{2} ( 0 ) ‖ 1 ) ( mod p )$$

$$where$$

$$Δ = \{ \begin{matrix}1 if id < {id}^{′} \\ - 1 if id > {id}^{′}\end{matrix}$$

wherein x_{id} represents the model training information obtained by the client node id, U₁ represents a set of identities of the first quantity of client nodes, PRG represents a Pseudo-Random Generator, g_{id}²(0) represents the private seed computed from the asymmetric bivariate polynomial G(0, id), p represents a roughly λ-bit prime, and λ is a security parameter.

### BRIEF DESCRIPTION OF THE DRAWINGS

The accompanying drawings, which are incorporated in and constitute a part of this specification, illustrate embodiments consistent with the present disclosure and together with the description serve to explain the principles of the present disclosure.

In order to more clearly illustrate technical solutions in embodiments of the present disclosure or in the conventional technology, the accompanying drawings to be used in the description of the embodiments or the conventional technology will be briefly introduced below. Obviously, other drawings may be obtained from these drawings by the skilled in the art without any creative effort.

FIG. 1 is a diagram of showing an iterative process among entities in a system for building blockchain-based secure aggregation in federated learning with data removal according to the present disclosure;

FIG. 2a is a flow chart of a method for building blockchain-based secure aggregation in federated learning with data removal according to an embodiment of the present disclosure;

FIG. 2b is a flow chart of a method for building blockchain-based secure aggregation in federated learning with data removal according to an embodiment of the present disclosure;

FIG. 3a is a flow chart of a method for building blockchain-based secure aggregation in federated learning with data removal according to another embodiment of the present disclosure;

FIG. 3b is a flow chart of a method for building blockchain-based secure aggregation in federated learning with data removal according to another embodiment of the present disclosure;

FIG. 4 is a flow chart of a method for building blockchain-based secure aggregation in federated learning with data removal according to yet another embodiment of the present disclosure;

FIG. 5 is a structural block diagram of a device for building blockchain-based secure aggregation in federated learning with data removal according to an embodiment of the present disclosure; and

FIG. 6 is a structural block diagram of a system for building blockchain-based secure aggregation in federated learning with data removal according to an embodiment of the present disclosure.

### DETAILED DESCRIPTION OF EMBODIMENTS

The exemplary embodiments of the present disclosure are described below in detail with reference to the drawings. It should be understood that the exemplary embodiments described below are used only to illustrate and interpret the present disclosure and are not intended to limit the present disclosure.

It should be noted that the exemplary embodiments of the present disclosure and features in the exemplary embodiments may be combined with each other in the case of no conflict, and all the combinations fall within the protection scope of the present disclosure. In addition, although a logical order is shown in the flowchart, the steps shown or described may be performed in a different order from the order here in some cases.

In implementations, a computing device that performs a method for building blockchain-based secure aggregation in federated learning with data removal may include one or more processors (CPU, Central Processing Module), an input/output interface, a network interface and a memory.

The memory may include a volatile memory, a random access memory (RAM) and/or a non-volatile memory and other forms in a computer readable medium, for example, a read-only memory (ROM) or a flash RAM. The memory is an example of the computer readable medium. The memory may include a module 1, a module 2, . . . , and a module N (N is an integer greater than 2).

The computer readable medium includes non-volatile and volatile media as well as removable and non-removable storage media. A storage medium may store information by means of any method or technology. The information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic disk storage or other magnetic storage devices, or any other non-transmission media, and may be used to store information accessible to the computing device.

In this disclosure, a method, device and system for building blockchain-based secure aggregation in federated learning with data removal are provided.

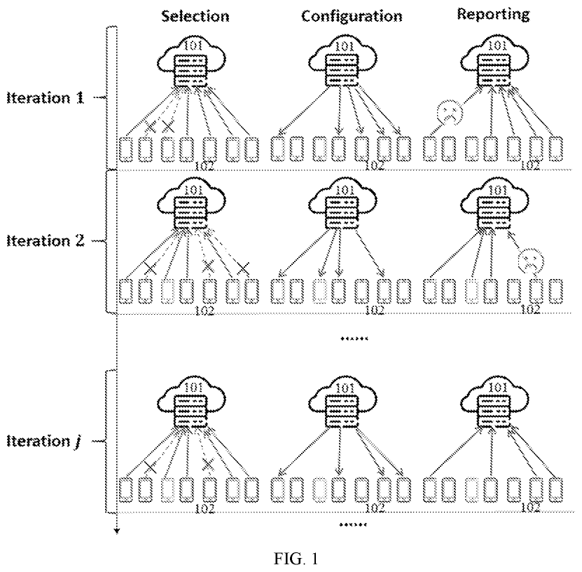

Reference is made to FIG. 1 which shows an iterative process among entities in a system for building blockchain-based secure aggregation in federated learning (FL) with data removal according to the present disclosure.

The core attraction of FL lies in its decentralized nature, where data remains locally stored among participating clients for training a machine learning model. Each client 102 shares model training information such as local model parameters or gradients (rather than data) to a server 101 which then combines all the model parameters or gradients to create a global model in a sharing round; this global model is then sent back to the clients for further training on their local data, and the process repeats, until the model convergences.

Nonetheless, as FL has gained prominence, it has also become a focal point for various privacy threats and integrity-compromising attacks. Specifically, the disclosure of local data privacy can inadvertently occur through the leakage of local gradient information. Furthermore, the adoption of global models introduces its own set of privacy risks. For example, a participating client may craft malicious updates with the intention of stealing private information from other participants. This can be achieved by observing the variations between the global models during successive training processes, such as discerning individual typing habits in a keyboard application. On the flip side, trust in the server 101 is not always guaranteed, and there is a potential for the server 101 to incorrectly aggregate models or return a global model that has been compromised, thereby posing a significant threat to data value and data privacy.

FL's evolving landscape introduces fresh challenges, such as the “Right to be Forgotten” (RTBF). In this context, participating clients may find the need to revoke the usage of their data during FL training, referred as the paradigm of federated unlearning, e.g., a client may request an application to stop tracking and collecting their text data.

There is need for addressing the privacy and integrity concerns in the RTBF context for two critical reasons below:
(a) Privacy Compromising of Forgotten Data against Honest-but-Curious Clients. The nature of FL permits both the server 101 and participating clients 102 to access the global model at the end of each sharing round in plaintext. Many prior security-enhancing mechanisms have tended to preserve this inherent characteristic. This characteristic opens the door to potential privacy breaches by honest-but-curious clients who may attempt to extract private information about deleted data.
(b) Lack of Verifiability for Proper Deletion or Deliberate Exclusion by a Malicious Server. FL server 101 may execute proper data deletion in response to deletion requests by constructing an unlearned model from the original aggregate model, effectively removing the specific model parameters associated with the data slated for deletion. However, there is need for schemes of verifying proper data deletion, a distinct challenge from cases involving malicious exclusion.

Still referring to FIG. 1, according to this embodiment of the disclosure, the server 101 manages a distributed and multi-iterative training procedure across many clients 102.

In some implementation, the training procedure is addressing the optimization problem of min_{M}Σᵢ₌₁ⁿf(M, Dⁱ), where f(M, Dⁱ) is the objective function for measuring the effectiveness of the parameters M in modeling the local data Dⁱ, and n is the number of participating clients 102. Initially, the server 101 distributes a global model with initial parameters M to all clients 102. Each client 102 participates in solving the optimization problem of min_{M}_{ⁱ}f(Mⁱ, Dⁱ), where the starting point is training the initial global model M over their local data to obtain a local model, by utilizing an optimization algorithm, e.g., the stochastic gradient descent (SGD) algorithm. Each client 102 particularly updates the local model parameters Mⁱ via

$${M}^{i} = M - η \cdot \frac{α f ( M , {B}^{i} )}{α M} = M - η \cdot Δ {M}^{i} ,$$

where η is the learning rate and Bⁱ is a batch of data randomly chosen from the local data Dⁱ. During a sharing round, the server 101 selects a subset of clients 102 to share their local models with the server 101, which then integrates them into a global model by

$$M = \frac{1}{n} {\sum }_{i = 1}^{n} {M}^{i} ,$$

according to an aggregation (or an averaging) rule. The aggregate result is then downloaded again by the clients 102, and is used to update their local models, and the clients 102 continue training over the same local data. Let M^{j} and Mⱼⁱ denote the global model and the i client's local model at the jₜₕ iteration, respectively.

The sever 101 coordinates the whole training procedure. The server 101 may store the per-client 102 local models and the global models in persistent storage in each sharing round.

There are a large number of clients 102 in dynamic connection with the server 101 via a network, e.g., WiFi. Each client 102 trains a local model on its local training data, and reports local model parameters to the server 101 in selected iterations.

During the process of cross-iteration training, some cases may arise, owing to various constraints faced by end clients 102, such as limited computing power, communication constraints, short battery life, or lack of interest in participating. With reference to the FIG. 1, the exemplary cases are as follows:
Rejection, denoted as the character “X” in FIG. 1. A client 102 might be unwilling to share local model parameters of certain iteration, such that the server 101 does not receive participation confirmation from it in the selection phase.
Dropout, denoted as the icon of a crying face in FIG. 1. Any client 102 might drop out at any time, owing to disconnecting the server 101 or running out of local resources.
Revocation, denoted as the dashed box in FIG. 1. A participating client 102 may request the server 101 to remove all contributions of its training data that has been included in the global model. For example, a mobile keyboard exercises its right of forgetting data, by requiring an app not to track and collect their data any more. Upon receiving the request, the server 101 needs to remove the client's parameters from the global models of the iterations the client 102 has participated in, by following the rule of RTBF. After the revocation, the remaining clients 102 continue the subsequent training on top of a new global model having removed the client's contributions.

In some examples, there is a potentially malicious server 101 capable of executing erroneous aggregate computations. The server 101 could produce malformed aggregate outcomes. Furthermore, the server 101 might encompass deliberate substitution of model parameters from some participating clients 102, or the strategic deletion of model parameters from clients 102 requesting data erasure. Detecting such misbehavior becomes more intricate during unlearning. For instance, the server 101 might aim to exclude an honest client's model update during regular learning, or irregularly incorporate a model update from a revoked client 102 during unlearning. However, honest clients 102 lack the ability to differentiate between revoked and non-revoked clients 102, exacerbating the challenge of identifying the server 101 misbehavior. The server 101 could also glean sensitive insights from each client's training data by initiating inference attacks on local or global models across multiple training iterations. In an especially malicious scenario, the server 101 might collaborate with a small subset of participating clients 102 to execute inference attacks. This disclosure seeks to alleviate privacy threats stemming from data deletion. In this context, adversaries could compromise the privacy of deleted data by analyzing models before and after unlearning.

It is assumed that clients 102 are honest-but-curious, which means they can honestly follow the training protocol, but try their best to learn private information of counterparts. Moreover, due to the inherent nature of FL, participating clients 102 consistently acquire global models irrespective of any revocation. Consequently, data that has been revoked might be susceptible to an attack from a client 102 capable of launching membership inference attacks on a global model before and after its deletion, similar to the malicious server 101 scenario previously mentioned. It is important to note that there are no overlapping data points across clients 102′ individual training sets. An embodiment of the present disclosure accounts for a fraction α of clients 102 that may drop out, as well as a fraction β that might become corrupted. Notably, the combined value of α and β does not exceed ½. An embodiment of the present disclosure imposes a requirement where at least a fraction ω of clients 102 must remain non-malicious to preserve privacy throughout each round of secure aggregation. It is notable that ω is set such that ω≥1−α−β. Lastly, an embodiment of the present disclosure assumes the presence of an authenticated secure channel between any two clients 102, possibly achieved through a signature-based mechanism or similar means.

### Security Goals

Model Privacy. In normal case, both local model privacy and global model privacy are protected: (1) Local model privacy. Each client's local models are protected against the server 101 and other clients 102. Aggregate results do not reveal any individual local model of a client. (2) Global model privacy. Aggregate results can only be accessed by participating clients 102, and cannot be obtained by the server 101.
Deletion Privacy. In this disclosure, there is two-fold deletion privacy: (1) Deletion Privacy Against Client. Some embodiments of the present disclosure protect the data privacy regarding any revoked client 102 against the remaining clients 102, even if they are able to access the aggregate models before and after data revocation. (2) Deletion Privacy Against Server 101. Some embodiments of the present disclosure guarantee global model privacy, such that the server 101 cannot infer any revoked client's private information from aggregate models during multi-iteration training.

Aggregation Verifiability. Some embodiments of the present disclosure provide aggregation verifiability for a participating client 102 to fast verify if aggregate outcomes are generated correctly. Regardless of deletion, the client 102 can be convinced that the aggregate out-comes are properly generated, rather than unexpectedly removing a participating client's local models, or non-compliantly including a revoked client's local models.

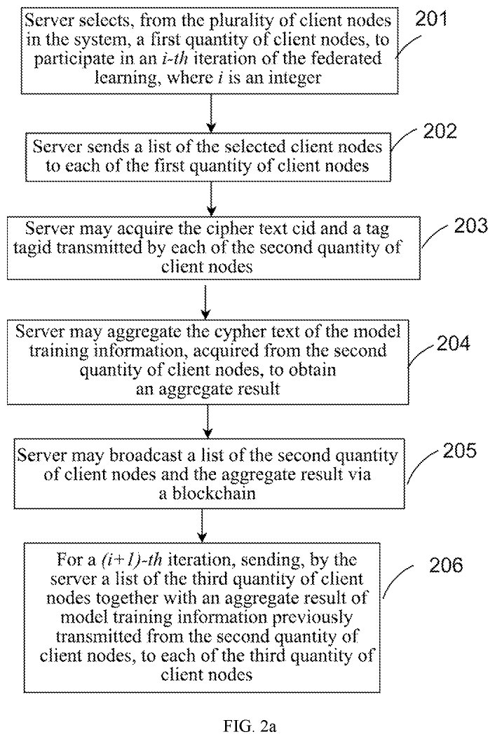

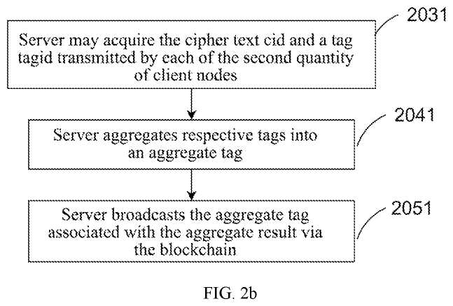

Now referring to FIG. 2a, which is a flow chart of a method for building blockchain-based secure aggregation in federated learning with data removal according to an embodiment of the present disclosure. The method is applied by a server in a system for building blockchain-based secure aggregation in federated learning with data removal. The system may include, among others, the server, a plurality of client nodes each being provided with a unique identifier id, and a block-chain. According to an embodiment, the method includes the following steps.

In S201, the server selects, from the plurality of client nodes in the system, a first quantity of client nodes, to participate in an i-th iteration of the federated learning, where i is an integer.

In S202, the server sends a list of the selected client nodes to each of the first quantity of client nodes.

For example, the server may send a list U1 of the identifiers of the first quantity of client nodes, to each of the selected client nodes.

In S203, the server may acquire model training information transmitted by each of a second quantity of client nodes among the first quantity of client nodes. The model training information is transmitted from the client nodes to the server in a form of cypher text. The client nodes separately train respective local models with their own local training data to obtain respective model training information.

In an embodiment of the present disclosure, the cypher text is generated by each client node through performing homomorphic encryption on his model training information based on pairwise seeds computed for each of the first quantity of client nodes from a symmetric bivariate polynomial and a private seed computed from asymmetric bivariate polynomial.

In an embodiment of the present disclosure, the symmetric bivariate polynomial F(x, y) and the asymmetric bivariate polynomial G(x, y) are selected and sent to the client nodes by a one-time dealer in an initialization process.

In an embodiment of the present disclosure, during the initialization process, system parameters are initialized, including n selected client nodes, their public and distinct identifiers id∈U={1, . . . , n} which are not zero, security parameter λ, threshold value t and h, the length of model training information (for example the gradient) parameters m, a large prime finite field R=Zₚ, where p is a roughly λ-bit prime larger than n, a pseudo-random generator PRG {0, 1}*→Z^{m}.

In an embodiment of the present disclosure, the one-time dealer is trusted, and is configured to select two secret keys s1, s2 from Zₚ; generate a symmetric bivariate polynomial associated with s1, F(x, y)=a₀₀₊a₁₀x+a₀₁y+a₁₁xy+ . . . +aₜ, x^{t}y^{t}(mod)p in which a_{i,j}=a_{j,i}, a_{i,j}, a_{j,i}∈Zₚ, i, j∈[0, t] and let F(0,0)=s₁, and then share each client node id∈ [n] with the secret key shares{f_{id}¹(y)=F(id, y), f_{id}²(x)=F(x, id)}, by separately substituting id for variable x and for variable y; generate an asymmetric bivariate polynomial of s₂, that is, G(x, y)=b₀₀x+b₀₁y+b₁₁xy+ . . . +b_{t,h}x^{t}y^{h}(mod p) in which b_{i,j}≠b_{j,i}, b_{i,j}, bⱼᵢ∈Zₚ, i∈[0, t], j∈[0, h], and let G(0,0)=s₂, and then share each client node id∈[n] with the secret key shares {g_{id}¹(y)=G(id, y), g_{id}²(x)=G(x, id)}.

In a preferable embodiment of the present disclosure, in the polynomials F(x, y) and G(x, y), the degree t, h satisfies the relationship of (t+1)t−1<h<n.

By utilizing the symmetric and asymmetric bivariate polynomials obtained in the initialization process, each client node can perform homomorphic encryption on his own model training information to obtain the cypher text of the model training information.

For example, for any client node id, the client node id can calculate a pairwise seed computed for another client node in U1 with identifier id′ from the symmetric bivariate polynomial as pairwise seeds f_{id}¹(id′)=F(id, id′). Due to the symmetric characteristics of F(x, y), F(id, id′)=F(id′, id). In addition, the client node id can calculate, from the asymmetric bivariate polynomial, a private seeds g_{id}²(0).

In an exemplary embodiment of the present disclosure, with the calculated seeds and together with the initialized pseudo-random generator PRG, the client node id can calculate the cypher text c_{id} of the model training information x_{id}, for example,

$$by {c}_{id} ← {x}_{id} + {\sum }_{{id}^{‵} ∈ {U}_{1} ∖ i d} Δ \cdot PRG ( {f}_{i d}^{1} ( {id}^{′} ) ) + PRG ( {g}_{i d}^{2} ( 0 ) ‖ 1 ) ( mod p )$$

$$where$$

$$Δ = \{ \begin{matrix}1 if id < {id}^{′} \\ - 1 if id > {id}^{′ \cdot }\end{matrix}$$

As described above and will be understood by those skilled in the art, there may be cases such as rejection or dropout in which some of the client nodes in U1 may be unwilling to share his model training information in the i-th iteration or may drop out owing for example to disconnecting from the server or running out of local resources. In such scenarios, the server could not acquire the cypher text of model training information from all of the first quantity of client nodes, but only from a subset U₂ of the first quantity of client nodes, namely, acquiring the cypher text of model training information from the second quantity of client nodes. In other words, U₂⊆U₁ and |U₂|>t.

In S204, the server may aggregate the cypher text of the model training information, acquired from the second quantity of client nodes, to obtain an aggregate result.

In an embodiment, the server may obtain the aggregate result Σc_{id}∈R^{m}.

In S205, the server may broadcast a list of the second quantity of client nodes and the aggregate result via a blockchain.

In an embodiment of the present disclosure, the server may broadcast the list ({id}_{id∈U}_{₂}, Σc_{id}) via the blockchain.

In an embodiment of the present disclosure, the client nodes may go through a consistency check thereafter. In this consistency check, each client node agrees the set of surviving counterparts, and the set size is larger than t. Otherwise, the consistency check is failed.

In an embodiment of the present disclosure, in the case the consistency check is successful, one client node from the second quantity of client nodes U2 can request the server to remove all contributions of its model training information that has been included in the previously generated aggregate result. By following the rule of RTBF, the revocation may be achieved in the following way, in accordance with an embodiment of the present disclosure.

For example, after receiving the request for revocation, in the (i+1)-th iteration, the server may determine currently on-line client nodes. For example, the on-line client nodes include the client nodes from the second quantity of client nodes except those who have requested revocation. In this case, the on-line client nodes form a sub set U3 of the second quantity of client nodes, in a third quantity.

In an embodiment of the present disclosure, the method may further include:

S206, for a (i+1)-th iteration, sending, by the server a list of the third quantity of client nodes together with an aggregate result of model training information previously transmitted from the second quantity of client nodes, to each of the third quantity of client nodes.

The server may send ({id}_{id∈U}_{₃}, Σc_{id}) to each of the third quantity of client nodes, where U₃⊆U₂∧|U₃|>t.

Each of the third quantity of client nodes, i.e., the on-line client node, can reconstruct local models to be used in the (i+1)-th iteration, based on ({id}_{id∈U}_{₃}, Σc_{id}).

In an embodiment of the present disclosure, each client node id from the third quantity of client nodes, can receive ({id}_{id∈U}_{₃}, Σc_{id}) from the server, compute (g_{id}¹(id′), g_{id}²(id′)) for each id′∈U₃\id, and securely transmit Lagrange Components of shares {g_{id′}²(id)·L_{id′}}_{id′∈U}_{₂} for recovering each g_{id′}²(0) and the corresponding shares for {f_{id′}²(id″)}_{id″∈U}_{₂}_{\U}_{₃}_{∧id″∈U}_{₁}_{\U}_{₂} via one-time encryption with previous pairwise shared keys. The pairwise shared keys g_{id}¹(id′), g_{id′}²(id) and g_{id′}¹(id), g_{id}²(id′) have been built between id and id′ owing to the initialization process. Then the client node id can reconstruct the local model Σx_{id″∈R}^{m} using the shares above from id′∈U₃.

As can be understood, the iterations repeat until the model convergences.

The method according to embodiments of the present disclosure, as described above, allows dropout-resiliency and corruption-tolerance guarantees, reduces communication and computational costs on the server side while not sacrificing the round complexity of communication, and protects the global model privacy against the server.

Furthermore, the method according to embodiments of the present disclosure, as described above, allows the data privacy regarding any revoked client against the remaining clients who can always obtain the aggregate models before and after data revocation.

In addition, the method according to embodiments of the present disclosure, as described above, integrates a lightweight homomorphic authentication mechanism.

In accordance with an exemplary implementation of the present disclosure, deletion privacy may be protected against potential inference attacks from curious remaining client nodes, by slightly adding discrete Gaussian noise to clients' local models before aggregation.

To be specifically, in S2031, the server may acquire the cipher text cid and a tag tagid transmitted by each of the second quantity of client nodes, where the cipher text cid and the tag tagid are computed by MaskAndMAC (pp, sk, id, xid)→(cid, tagid), wherein pp represents a public parameter component available to the server and the client nodes, sk represents secret key secretly shared among the client nodes.

In S2041, the server aggregates respective tags into an aggregate tag.

In S2051, the server broadcasts the aggregate tag associated with the aggregate result via the blockchain.

In this way, the deletion privacy may be further protected.

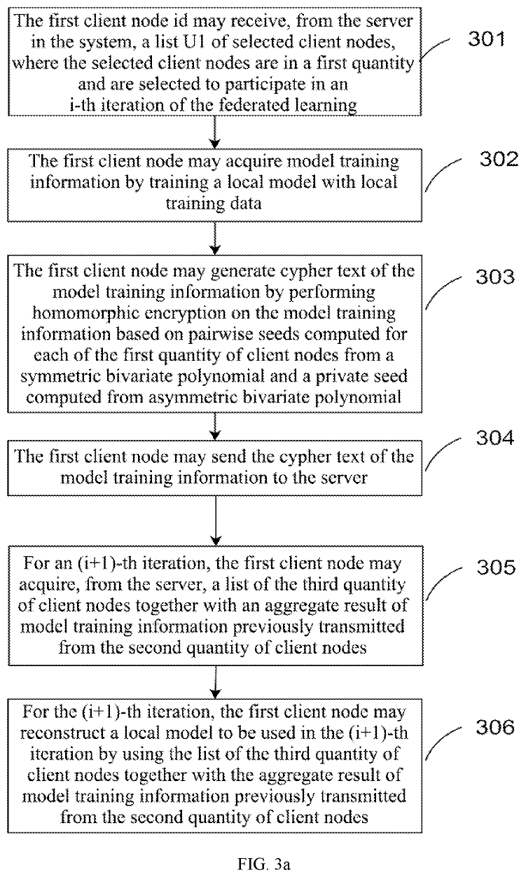

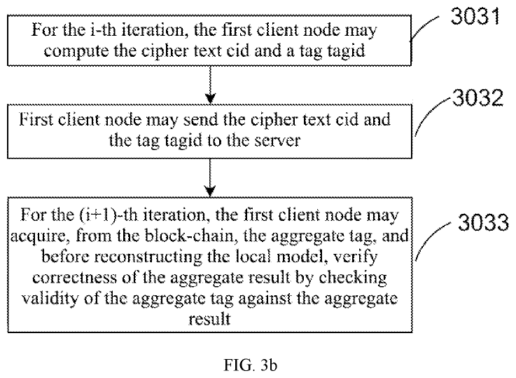

Now referring to FIG. 3a, which is a flow chart of a method for building blockchain-based secure aggregation in federated learning with data removal according to another embodiment of the present disclosure. The method may be applied by a first client node in a system for building blockchain-based secure aggregation in federated learning with data removal. The system may include, among others, the server, a plurality of client nodes each being provided with a unique identifier id, and a block-chain. According to an embodiment, the method includes the following steps.

In S301, the first client node id may receive, from the server in the system, a list U1 of selected client nodes, where the selected client nodes are in a first quantity and are selected to participate in an i-th iteration of the federated learning, where i is an integer. The first quantity of client nodes are selected by the server from the plurality of client nodes in the system, and the first client node is one of the first quantity of the selected client nodes.

In S302, the first client node may acquire model training information by training a local model with local training data.

The first quantity of client nodes may separately train their local model with their own local training data to acquire respective model training information.

In S303, the first client node may generate cypher text of the model training information by performing homomorphic encryption on the model training information based on pairwise seeds computed for each of the first quantity of client nodes from a symmetric bivariate polynomial and a private seed computed from asymmetric bivariate polynomial.

In an embodiment of the present disclosure, the symmetric bivariate polynomial F(x, y) and the asymmetric bivariate polynomial G(x, y) are selected and sent to the client nodes by a one-time dealer in an initialization process.

In an embodiment of the present disclosure, during the initialization process, system parameters are initialized, including n selected client nodes, their public and distinct identifiers id∈U={1, . . . , n} which are not zero, security parameter λ, threshold value t and h, the length of model training information (for example the gradient) parameters m, a large prime finite field R=Zₚ, where p is a roughly λ-bit prime larger than n, a pseudo-random generator PRG {0, 1}*→Z^{m}.

In an embodiment of the present disclosure, the one-time dealer is trusted, and is configured to select two secret keys s1, s2 from Zₚ; generate a symmetric bivariate polynomial associated with s1, F(x, y)=a₀₀₊a₁₀x+a₀₁y+a₁₁xy+ . . . +aₜ, x^{t}y^{t}(mod)p in which a_{i,j}=a_{j,i}, a_{i,j}, a_{j,i}∈Zₚ, i, j∈[0, t] and let F(0,0)=s₁, and then share each client node id∈[n] with the secret key shares {f_{id}¹(y)=F(id, y), f_{id}²(x)=F(x, id)}, by separately substituting id for variable x and for variable y; generate an asymmetric bivariate polynomial of s₂, that is, G(x, y)=b₀₀x+b₀₁y+b₁₁xy+ . . . +b_{t,h}x^{t}y^{h}(mod p) in which b_{i,j}≠b_{j,i}, b_{i,j}, bⱼᵢ∈Zₚ, i∈[0, t], j∈[0, h], and let G (0,0)=s₂, and then share each client node id∈[n] with the secret key shares {g_{id}¹(y)=G(id, y), g_{id}²(x)=G(x, id)}.

In a preferable embodiment of the present disclosure, in the polynomials F(x, y) and G(x, y), the degree t, h satisfies the relationship of (t+1)t−1<h<n.

By utilizing the symmetric and asymmetric bivariate polynomials obtained in the initialization process, each client node can perform homomorphic encryption on his own model training information to obtain the cypher text of the model training information.

For example, the first client node id can calculate a pairwise seed computed for another client node in U1 with identifier id′ from the symmetric bivariate polynomial as pairwise seeds f_{id}¹(id′)=F(id, id′). Due to the symmetric characteristics of F(x, y), F(id, id′)=F(id′, id). In addition, the client node id can calculate, from the asymmetric bivariate polynomial, a private seeds g_{id}²(0).

In an exemplary embodiment of the present disclosure, with the calculated seeds and together with the initialized pseudo-random generator PRG, the first client node id can calculate the cypher text c_{id} of the model training information x_{id}, for example, by c_{id}←x_{id}+Σ_{id′∈U}_{₁}_{\id}Δ·PRG(f_{id}¹(id′))+PRG(g_{id}²(0)∥1)(mod p) where

$$Δ = \{ \begin{matrix}1 if id < {id}^{′} \\ - 1 if id > {id}^{′ \cdot }\end{matrix}$$

In S304, the first client node may send the cypher text of the model training information to the server.

As described above and will be understood by those skilled in the art, there may be cases such as rejection or dropout in which some of the client nodes in U1 may be unwilling to share his model training information in the i-th iteration or may drop out owing for example to disconnecting from the server or running out of local resources. In such scenarios, the server could not acquire the cypher text of model training information from all of the first quantity of client nodes, but only from a subset U₂ of the first quantity of client nodes, namely, acquiring the cypher text of model training information from the second quantity of client nodes. In other words, U₂⊆U₁ and |U₂|>t. In this way, the server may obtain the aggregate result Σc_{id}∈R^{m}.

As described above and will be understood by those skilled in the art, there may be case of revocation, in which one client node from the second quantity of client nodes U2 can request the server to remove all contributions of its model training information that has been included in the previously generated aggregate result. In this case, the server may determine currently on-line client nodes. For example, the on-line client nodes include the client nodes from the second quantity of client nodes except those who have requested revocation. In this case, the on-line client nodes form a sub set U3 of the second quantity of client nodes, in a third quantity.

In an embodiment of the present disclosure, the method may further include the following steps.

In S305, for an (i+1)-th iteration, the first client node may acquire, from the server, a list of the third quantity of client nodes together with an aggregate result of model training information previously transmitted from the second quantity of client nodes.

In S306, for the (i+1)-th iteration, the first client node may reconstruct a local model to be used in the (i+1)-th iteration by using the list of the third quantity of client nodes together with the aggregate result of model training information previously transmitted from the second quantity of client nodes.

In an exemplary implementation, the reconstructing the local model to be used in the (i+1)-th iteration may include:
computing private seeds (g_{id}¹(id′), g_{id}²(id′)), for each of the third quantity of client nodes, which is of identifier id′, wherein g_{id}¹(id′)=G(id, id′), g_{id}²(id′)=G(id′, id), id′∈U₃\id, U₃ represents a set of the identifiers of the third quantity of client nodes;
transmitting Lagrange Components of shares {g_{id′}²(id)·L_{id′}}_{id′∈U}_{₂} for recovering each g_{id′}²(0) and corresponding shares for {f_{id′}²(id″)}_{id″∈U}_{₂}_{\U}_{₃}_{∧id″∈U}_{₁}_{\U}_{₂} via one-time encryption with previous pairwise shared keys, wherein L_{id′} represents Lagrange Component; and
reconstructing the local model using the shares above from id′∈U₃.

To provide improved privacy protection with regard to data revocation, discrete Gaussian noise may be added to clients' local models before aggregation, as described with reference to FIG. 3b.

In S3031, for the i-th iteration, the first client node may compute the cipher text cid and a tag tagid by MaskAndMAC(pp, sk, id, xid)→(cid, tagid), wherein pp represents a public parameter component available to the server and the client nodes, sk represents secret key secretly shared among the client nodes, and xid represents the model training information of the first client node id.

In S3032, the first client node may send the cipher text cid and the tag tagid to the server.

In this implementation, the server may aggregate respective tags into an aggregate tag and broadcast the aggregate tag associated with the aggregate result via the blockchain.

In S3033, for the (i+1)-th iteration, the first client node may acquire, from the block-chain, the aggregate tag, and before reconstructing the local model, verify correctness of the aggregate result by checking validity of the aggregate tag against the aggregate result.

The methods for building blockchain-based secure aggregation in federated learning with data removal may find application in a variety of fields, such as Internet of Things (IoT), healthcare, etc.

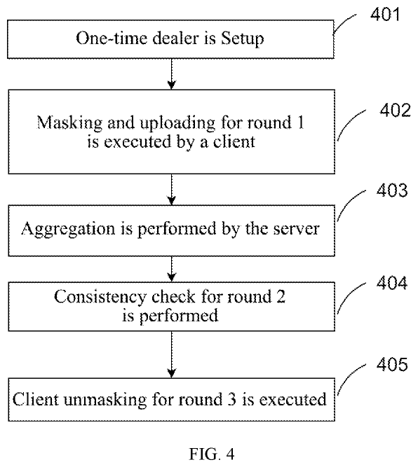

In the following, a method (or may be referred to as protocol) for building blockchain-based secure aggregation in federated learning with data removal according to another embodiment of the present disclosure is described with reference to FIG. 4. The method is applicable in a system including a server, a plurality of clients each being provided with a unique identifier id, and a block-chain.

All participating clients have access to a public bulletin board, e.g., blockchain. The blockchain may store all historical masked aggregate models and the corresponding identities of the involved clients. The blockchain is very useful for consistency check among clients at runtime. This work employs a permissioned blockchain involving a small group of members who are organized by a secure consensus protocol. Off-the-shelf blockchains, such as Hyperledger, BCOS can be adopted.

In this embodiment of the present disclosure, bivariate polynomial-based secret sharing (BPSS) is adopted. A dealer can hide a secret in the constant term of the bivariate polynomial. The dealer may compute two polynomials related to the secret as well as a participant's identifier, and then, securely distribute the two polynomials (instead of a point) to the participant. Formally, a bivariate polynomial is defined as F(x, y)=Σᵢ₌₀^{t}Σⱼ₌₀^{t}a_{i,j}xⁱyⁱ mod Zₚ with the same degree t in variate x and in variate y, where p is a large prime and a_{i,j}∈Zₚ. A dealer chooses a secret s∈Zₚ and let F(0,0)=s. According to the coefficient features, a bivariate polynomial can be grouped into symmetric bivariate polynomial (SBP) if a_{i,j}=a_{j,i}, and asymmetric bivariate polynomial (ABP) if a_{i,j}≠a_{j,i}. Such features bring some advantages to the BPSS. Concretely, for symmetric BPSS, a participant i is configured with shares {F(i,y)=F(x,i)}. A pair of shared keys then can be established between participant i and j due to F(i,j)=F(j,i). For asymmetric BPSS, there are two pairwise shared keys between participant i and j, that is, F(i,j) and F(j,i).

The derived secret sharing mechanism satisfies the additive homomorphism property. Formally, let χ be the share domain, Y be the secret domain and ⊕ be the addition operation. Denote Fᵣ as a secret reconstruction function for a (t+1, n)-BPSS mechanism. The previously described BPSS mechanism has the additive homomorphism property, if for all sets of (t+1) shares, whenever y=Fᵣ(x₁, . . . , xₜ₊₁) and y′=Fᵣ(x₁, . . . , xₜ₊₁) then y⊕y′=Fᵣ(x₁⊕x′₁, . . . , xₜ₊₁⊕x′ₜ₊₁).

A secure Pseudo-Random Generator (PRG) is required in this embodiment of the present disclosure, which extends a fixed-size uniformly random seed to a m-length random number of a prime field as output. The PRG is secure if the output is computationally indistinguishable from a uniformly selected number from the same prime field. More importantly, a key-homomorphic PRG mechanism may be adopted that enables ΣPRG(kᵢ)=PRG(Σkᵢ). The main reason is that the PRG computation of each seed for masking gradients dominates the computation overhead of clients.

In S401, one-time dealer is Setup. System parameters are initialized, including n selected clients, their public and distinct identifiers id∈U={1, . . . , n} which are not zero, security parameter λ, threshold value t and h, the length of gradient parameters m, a large prime finite field R=Zₚ. p is a roughly λ-bit prime, which is larger than n. A pseudo-random generator PRG {0, 1}*→Zₚ^{m}.

A trusted dealer is entitled to:
(1) select two secret keys s1, s2 from Zₚ;
(2) generate a symmetric bivariate polynomial associated with s1, F(x, y)=a₀₀₊a₁₀x+a₀₁y+a₁₁xy+ . . . +aₜ, x^{t}y^{t}(mod)p in which a_{i,j}=a_{j,i}, a_{i,j}, a_{j,i}∈Zₚ, i, j ∈[0, t] and let F0,0)=s₁; Then, share each client id∈[n] with the secret key shares {f_{id}¹(y)=F(id, y), f_{id}²(x)=F(x, id)}, by separately substituting id for variable x and for variable y;
(3) generate an asymmetric bivariate polynomial of s₂, that is, G(x, y)=b₀₀x+b₀₁y+b₁₁xy+ . . . +b_{t,h}x^{t}y^{h}(mod p) in which b_{i,j}≠b_{j,i}, b_{i,j}, bⱼᵢ∈Zₚ, i∈[0, t], j∈[0, h], and let G(0,0)=s₂; Then, share each client id∈[n]with the secret key shares {g_{id}¹(y)=G(id, y), g_{id}²(x)=G(x, id)}.

Note that in the above polynomials, the degree t, h satisfies the relationship of (t+1)t−1<h<n.

In S402, masking and uploading for round 1 is executed by a client. The Client id is to:
(1) receive the selected client list U₁⊆U from the server and check |U₁|>t; otherwise, aborts.
(2) compute pairwise seeds f_{id}¹(id′) where id′∈U₁. Note that f_{id}²(id)=f_{id}¹(id′).
(3) compute private seeds g_{id}²(0).
(4) compute masked inputs c_{id}←x_{id}+Σ_{id′∈U}_{₁}_{\id}Δ·PRG(f_{id}¹(id′))+PRG(g_{id}²(0)∥1)(mod p) where

$$Δ = \{ \begin{matrix}1 if id < {id}^{′} \\ - 1 if id > {id}^{′}\end{matrix}$$

(5) send c_{id} to the server if the computation above is correct.

In S403, aggregation is performed by the server. The server is to:
(1) Receive c_{id} from on-line clients id∈U₂⊆U₁ and |U₂|>t; otherwise, aborts.
(2) aggregate all masked inputs Σc_{id}∈R^{m}.
(3) broadcast the list ({id}_{id∈U}_{₂}, Σc_{id}) to the clients via the public bulletin board.

In S404, consistency check for round 2 is performed, in which each client agrees the set of surviving counterparts, and the set size is larger than t. Otherwise, the protocol aborts.

In S405, client unmasking for round 3 is executed. The client id is to:
(1) receive ({id}_{id∈U}_{₃}, Σc_{id}) from the server, and continue if U₃⊆U₂∧|U₃|>t; otherwise, aborts.
(2) Compute (g_{id}¹(id′), g_{id}²(id′)) for each id′∈U₃\id.

//pairwise shared keys g_{id}¹(id′), g_{id′}²(id) and g_{id′}¹(id), g_{id}²(id′) have been built between id and id′ owing to the Dealer Setup round.
(3) securely transmit Lagrange Components of shares {g_{id′}²(id)·L_{id′}}_{id′∈U}_{₂} for recovering each g_{id′}²(0) and the corresponding shares for {f_{id′}²(id″)}_{id″∈U}_{₂}_{\U}_{₃}_{∧id″∈U}_{₁}_{\U}_{₂} via one-time encryption with previous pairwise shared keys. Herein, L_{id′} is computed according to Lagrange interpolation formula.
(4) reconstruct the aggregate local models Σx_{id″}∈R^{m} using the shares above from id′∈U₃.

To provide better understanding of the embodiments of the present disclosure, a four-client scenario with the foregoing protocol that does not consider deletion privacy is described.

One-Time Dealer Setup: A dealer generates an SBP F(x, y)=2+x+y+4xy and an ABP G(x, y)=3+x+2y+xy+4y2+2xy2. Herein, the coefficients are from a non-zero field R. Each client id∈{1, 2, 3, 4} is shared with secret keys as follows:

1: {F (1, y), F (x, 1)} and {G(1, y), G(x, 1)}.
2: {F (2, y), F (x, 2)} and {G(2, y), G(x, 2)}.
3: {F (3, y), F (x, 3)} and {G(3, y), G(x, 3)}.
4: {F (4, y), F (x, 4)} and {G(4, y), G(x, 4)}.

With the setup, the protocol involves four clients, and allows one dropped client and one corrupted client at any time of subsequent execution.

Masking and Uploading: Individual client id∈{1, 2, 3,4} masks its local gradient x_{id} which belongs to the non-zero field R (assuming |x_{id}|=1 for simplicity), by using secret keys as follows:

$$1 : c 1 = x 1 + F ( 1 , 2 ) + F ( 1 , 3 ) + + G ( 0 , 1 ) .$$

$$2 : c 2 = x 2 - F ( 2 , 1 ) + F ( 2 , 3 ) + +$$

$$3 : c 3 = x 3 - F ( 3 , 1 ) - F ( 3 , 2 ) + + G ( 0 , 3 ) .$$

$$4 : c 4 = x 4 - F ( 4 , 1 ) - F ( 4 , 2 ) - F ( 4 , 3 ) + G ( 0 , 4 ) .$$

It is assumed that the 4ₜₕ client drops out in this round, so the gradients the server receives are from the first three clients. Finally, the gradient sum is Σ_{id∈{1,2,3}}c_{id}.

Client Unmasking: With Σ_{id∈{1,2,3}}c_{id} returned by the server, the clients collaborate to unmask the sum. It is assumed that client 2 is corrupted in this round. The collaboration of the remaining honest clients with id=1 and id=3 should successfully decrypt and obtain Σ_{id∈{1,2,3}}c_{id}. Note that F (1, 2), F (1, 3), F (2, 1), F (2, 3), F (3, 1), F (3, 2) can be mutually cancelled out, and therefore, the next-step computation is to remove F (2, 4), F (1, 4), F (3, 4) and to recover G(0, 2), G(0, 1), G(0, 3). It is noted that two pairwise shared keys {G(1, 3), G(3, 1)} are pre-established between client 1 and 3, such that they can privately exchange the Lagrange Components of shares

$$F ( 1 , 4 ) \times \frac{x - 3}{1 - 3}$$

and

$$G ( 1 , 2 ) \times \frac{x - 3}{1 - 3} ,$$

as well as

$$F ( 3 , 4 ) \times \frac{x - 1}{3 - 1}$$

and

$$G ( 3 , 2 ) \times \frac{x - 1}{3 - 1}$$

via private channels. Then, F(x,4) and G(x,2) are and reconstructed via Lagrange interpolation, and thus F (2, 4) and G(0, 2) are obtained. Similarly, the clients can recover G(0, 1) and G(0, 3) in a similar way. As a result, client 1 and 3 can obtain the gradient sum Σ_{id∈{1,2,3}}x_{id}.

It is noted that the total number of clients should be at least larger than three timing number of corrupted clients (introduced in the next section). It is emphasized that the clients 1 and 3 are honest, and they do not collude to recover F (x, y), in the masking and uploading phase, to recover an individual client's gradient.

To provide better understanding of the embodiments of the present disclosure, a general description of the foregoing protocol is provided with four rounds. A centralized server coordinates the communication and aggregates the trained gradients of n clients which are selected in an iteration of the FL training. A gradient is denoted to be an m-length vector with elements in a field of Zₚ. The identity of each client is unique and denoted as id∈{1, . . . , n}, for easy of presentation. Denote that the client id's local gradient is x_{id} which is a m-length vector in Zₚ, i.e., |x_{id}|=m.

To start with, a trusted dealer is entitled to generate two secrets, and to configure the shares of the secrets for each client using polynomial derivatives. A symmetric bivariate polynomial has the degree t in variable x and y, and an asymmetric bivariate polynomial has the degree t in x and the degree h in y, where (t+1)t−1<h<n. Recall that the degree t and the degree h utilized by the previously described toy protocol are 1 and 2, respectively. Owing to such a setup, it is allowed dropped or corrupted clients that may occur at any time, and the remaining clients are able to recover the final sum, as long as the honest client count is more than t. Moreover, every pair of two clients shares two pairs of common keys for privately exchanging messages, such that secure recovery can be completed at the client side, rather than the server side. Also, the clients are not required to establish key agreement, e.g., Diffie-Hellman key agreement. Notice, a consistency round is involved for ensuring that all surviving clients have a consistent view about counterparts. With such a consistent view, surviving clients are able to exchange shares via private communication, in order to recover the aggregate local models.

It is noted that t<n/3 can ensure the accurate reconstruction of secrets. This relationship is established based on principles from coding theory. In scenarios where the client count is represented by n, the system can tolerate up to (n−t)/2 instances of corruption. Hence, the condition t<(n−t)/2 holds great significance to guarantee the precision of secret reconstruction. In practice, the condition t<(n−t)/2 remains satisfied, provided that the two polynomials F (x, y) and G(x, y) are designed according to the parameter setting (t+1)t−1<h<n.

The communication cost for the server is dominated by receiving the masked inputs from participating clients, which is O(mn). The server's computation cost is only caused by aggregating the clients' masked inputs and each one is m length, resulting in O(m).

To provide better privacy protection, a refined protocol is further provided according to another embodiment of the present disclosure, in presence of data revocation. Let each client obtain a noisy aggregate result of all clients' local models, when the unmasking phase is done. It aims to provide client-level DP, which prevents non-revoked clients from learning private data associated with a revoked client.

Note that the privacy requirement is weaker than that of local DP, and the noise introduced at the individual client level is not adequate to guarantee DP on its own. Therefore, the privacy preservation of a noisy local model greatly depends on the security of the foregoing protocol. For example, a delayed client's noisy local model is privacy-preserving, only if the majority of clients and the server are honest, since the foregoing protocol allows client dropout and corruption at any time.

In considered scenario, DP is defined associated with the addition or exclusion of all local data belonging to a single client (cf. D′), which achieves client-level privacy.

Definition 1: (Differential Privacy) The [symbol] mechanism is (ε, δ)-differentially private, where ε>0 and δ≥0, iff for all possible output sets S and for any two neighboring datasets D₁ and D₂ differing by a dataset D′, i.e., D1−D2=D′or D2−D1=D′, have Pr[M(D1)∈S]≤(1+ε)·Pr[M(D2)∈S]+δ.

In the above definition, ε>0 bounds the distinguishability of all possible output sets on the adjacent datasets D₁ and D₂; δ≥0 refers to the probability that (1+ε) fails to bound the datasets D₁ and D₂, using the noisy mechanism M. M:D→R is defined with a domain D, e.g., training sets, and with a range R, e.g., all trained global models. The notion of DP implies that the parameter distributions of two models trained on datasets D₁ and D₂ are indistinguishable, where D₁ and D₂ differ only in a specific client's local data.

Definition 2: (Rényi Differential Privacy) The M mechanism is (α,1/2ε²α)-differentially private, where α∈(1, ∞), iff for all possible output sets S and for any two neighboring datasets D₁ and D₂ differing by a dataset D′, the Rényi divergence of order a of two outputs M(D₁)∈S and M(D₂)∈S is represented

$$by {H}_{α} ( ℳ ( {D}_{1} ) ‖ ℳ ( {D}_{2} ) ) \leq \frac{1}{2} {ε}^{2} α .$$

Sensitivity for Querying Global Model

$$M = \frac{1}{n} {\sum }_{i = 1}^{n} {M}^{i} .$$

Recall that Mⁱ is the local model learnt over the iₜₕ client's training set. It is assumed that the size of each client training set is equal, and therefore, the M is influenced by the data associated with a particular client with an equal proportion. It is defined the sensitive of querying M as

$${S}_{M} = {max}_{} {‖ \frac{1}{n} {\sum }_{i = 1}^{n} {M}^{i} - \frac{1}{n - 1} {\sum }_{i = 1 ∧ i \neq }^{n} {M}^{i} ‖}_{2} .$$

If any local model Mⁱ has bounded norm c, that is, ∥Mⁱ∥₂≤c, then the S_{M} is bounded at most c. However, a local model may not be bounded by the desired c. Each client is to clip the local model, achieving ∥Mⁱ∥₂≤c.

Randomized Hadamard Transform: The DP mechanism can be integrated with the foregoing protocol by doing modular arithmetic. In order to mitigate the errors caused by modular rounding, the Hadamard transform operation as Definition 3 shown will be adopted, which consumes O(m log m) for a m-dimension gradient vector x. Herein, assume m is a power of 2. Notice, the definition uses a Walsh-Hadamard matrix denoted in Definition 4.

Definition 3: The randomized Hadamard transform operation on a m-dimension vector x=(x₁, . . . , xₘ) is defined as

$$\frac{H D}{\sqrt{m}} \cdot x = \frac{1}{\sqrt{m}} H \cdot ( {x}_{1} \cdot {d}_{1 , 1} , … , {x}_{m} \cdot {d}_{m , m} ) ∈ {\{ - 1 , + 1 \}}^{m}$$

are the diagonal values of the m×m matrix D. Also the inverse transform operation is denoted as

$$\frac{H D}{\sqrt{m}} \cdot x .$$

Definition 4: The Walsh-Hadamard matrix Hₘ∈{−1, +1}^{m×m} is defines as

$${H}_{m} = ( \begin{matrix}{H}_{m / 2} & {H}_{m / 2} \\ {H}_{m / 2} & - {H}_{m / 2}\end{matrix} ) ,$$

and when m equals to 1, Hₘ=(1), which satisfies

$$( \frac{1}{\sqrt{m}} H ) \cdot {( \frac{1}{\sqrt{m}} H )}^{T} = I .$$

Let the server only do the aggregation calculation. For adapting to the modular integer arithmetic of Foregoing protocol, the client rounds the float-type model parameters, and adds noise sampled from discrete Gaussian distribution. Notice, this step happens before the phase of masking and uploading. As demonstrated by Algorithm 1, each client scales and clips the local model x_{id} to ensure ∥x_{id}∥₂≤c/γ. Then, each client performs the randomized Hadamard transform operation on x_{id}, and proceeds to round x_{id}, such that the resulting integer-type x_{id} is sufficiently small. After that, the client perturbs the parameters with the noise

$${ϑ}_{i} ← {N}_{{Z}_{p}} ( 0 , \frac{{σ}^{2}}{{γ}^{2}} ) .$$

Last, each client undoes the rounding of the unmasked aggregate outcome Σx_{id}, that belongs to Zₚ (see the unmaking phase in FIG. 3), by performing inverse transform

$$γ \frac{D H}{\sqrt{m}} ,$$

and finally, obtains the float-type Σx_{id′}.

Depart from protecting the privacy of the client inputs on the case of data revocation or non-revocation, it is further addressed the issue of enforcing the authenticity of the server-side computation. Despite the existence of many verifiable aggregation mechanisms, they do not solve the problem comprehensively, since the case of proper deletion at server is not considered. It is specifically considered a case where an honest counterpart proactively revokes his participation from the training process, and it is to convince a surviving client that his local models are properly removed from the global models, instead of being maliciously excluded by the untrusted server. Therefore, an enhanced protocol is proposed to provide the authenticity guarantees of the server aggregation, and mean-while, enable fast verification for resource-restrained clients.

In the enhanced protocol according to an embodiment of the present disclosure, homomorphic message authentication codes (HMACs) are introduced. Let K, M, I be the key space, the message space and the index space. There are three probabilistic polynomial-time (PPT) algorithms as follows:
GenMAC(k,mᵢ): Taking as inputs a secret key k∈K and a message mᵢ∈M, i∈I, the algorithm outputs an MAC tag tᵢ for the message mᵢ.
Verify(k, tᵢ, mᵢ)→0 or 1: Taking as inputs a secret key k, a message mᵢ and an MAC tag tᵢ the algorithm outputs 0 or 1 which means “reject” or “accept”.
Combine((m₁, t₁, α₁), . . . , (mₙ, tₙ, αₙ))→t: Taking as inputs a set of messages m₁, . . . , mₙ∈M, their MAC tags t₁, . . . , tₙ generated by the same secret key k, and a set of constants a₁, . . . , aₙ, the algorithm outputs a tag t for the message m←Σᵢ₌₁ⁿaᵢmᵢ.

Zero-Knowledge Proof ZK enables a prover who holds a private witness with to convince a verifier of a statement C(wit)=1 without revealing the witness, where C is the evaluating circuit known by both the prover and verifier. ZK proof protocols (such as zero-knowledge succinct non-interactive arguments of knowledge [18]) now become possible to support generic computation via the reduction to generic NP-complete problem.

In the enhanced protocol according to an embodiment of the present disclosure, at a high-level view, the HMAC is adopted, represented as a tag tag, to verify the correctness of a sum Σc_{id} that aggregates a specific set of cipher text c_{id}, (id∈U). On the case of data revocation, assuming the revocation of the client id∈U's data, it is needed to attest the authenticity of an updated sum Σc_{id}\ [symbol] by providing an updated tag [symbol] , as well as an additional proof. This proof is provided by the client [symbol] . It is an ownership proof [symbol] attesting that client's [symbol] is ever included in the Σc_{id}, and meanwhile, not included in Σc_{id}\ [symbol] . Then, the server can forward the proof [symbol] to convince the other remaining clients that the claimed cipher text Σc_{id}\ [symbol] is properly generated under the agreement of the client \hat{ }id.

A tuple of four PPT algorithms is involved in the enhanced protocol according to an embodiment of the present disclosure. For simplicity, it is denoted in the following algorithms that |U| is larger than a pre-configured security threshold. In addition, let ‘msg’ indicate if a client revokes his message or not in an aggregation round. The ‘msg’ can be a message ‘revocation’ or ‘non-revocation’.
Setup(1^{λ})→(pp, sk): It outputs a public parameter component pp and a secret key component sk. sk is secretly shared among the clients, while pp containing the PRG, U, M and p parameters are publicly available to both the server and the clients.
MaskAndMAC(pp, sk, id, xid)→(cid, tagid): The algorithm is executed at client. Taking the secret key sk, id∈U and the message xid∈M as input, it outputs a cipher text cid along with a tag tagid.
AggAndProve(pp, T, C, ‘msg’)→(c, tag) or (c\hat{ }, ta\hat{ }g, π_{i\hat{ }d}): The algorithm is run by the server. Taking the pp, a set of cipher text C=(c1, . . . , c|U|) and a set of tags T=(tag1, . . . , tag|U|) as inputs, the output of the algorithm contains:
   (a) (c, tag): c←Σid∈U cid as the cipher text sum and [symbol] ←Σ_{id∈U} tag_{id}, as the tag sum, if the ‘msg’ is assigned with ‘non-revocation’;
   (b) (ĉ, [symbol] , [symbol] ): \hat{ĉ}←Σ_{id∈U\} [symbol] c_{id} and [symbol] ←Σ_{id∈U\} [symbol] ia tag_{id}, as well as the ownership proof [symbol] provided by the client [symbol] , if the ‘msg’ is assigned with ‘revocation’ and suppose the currently revoked message [symbol] originally exists in C.

$$Unmask And Verify ( pp , sk , c or \hat{c} , tag or , ) \to ( 0 , ⊥ ) or ( 1 , x ) :$$

The algorithm is run at client. By taking as input the public parameters, the secret key, the cipher text sum, the tag sum and possibly an ownership proof, it verifies the validity of the tag respective to the cipher text, as well as the validity of the ownership proof. If it is valid, the algorithm outputs 1 representing “accept” and the aggregate result x; otherwise, it outputs 0 standing for “reject”.

The enhanced protocol according to an embodiment of the present disclosure is provided below. The enhanced protocol runs the same steps as the previous protocol, except for proof generation in the aggregation phase, and verification required to check the computation correctness of a server in the phase of client unmasking.

One-Time Dealer Setup: There are the same algorithm parameters as that in S401, except for selecting s₃∈Zₚ, and distributing it to all Participating clients via secure channels.

Masking and Uploading (Round 1): The phase achieves the aforementioned MaskAndMAC algorithm. Each client executes the same computation as that in S402, except for computing an HMAC-enabled tag with respect to each ciphertext c_{id}:

$${tag}_{id} = \frac{PRG ( {g}_{id}^{2} ( 0 ) ‖ 2 - {c}_{id} )}{{s}_{3}} mod p .$$

Define an one-degree polynomial y^{id}(x)=c_{id}+tag_{id}x∈Zₚ[x], such that y^{id}(0)=c_{id} and PRG(g_{id}²(0)∥2.

Aggregation: The phase achieves the AggAndProve algorithm. In a normal case, the server aggregates the HMACs of the ciphertexts by computing tag←Σ_{id∈U}tag_{id}, in addition to aggregating the ciphertext c←Σ_{id∈U}c_{id}. In a revocation case, upon receiving tag [symbol] ∈T of a revocation requester and a publicly verifiable proof [symbol] , the server computes c←Σ_{id∈U\} [symbol] c_{id} which can be verified by [symbol] . Herein, [symbol] +tag [symbol] =tag and [symbol] =Σ_{id∈U\} [symbol] tag_{id}.

Consisteney Check (Round 2)

Client Unmasking (Round 3): The phase achieves the UnmaskAnd. Verify algorithm. Before unmasking the aggregate ciphertext as the previously described S405, each client verifies the correctness of the aggregate ciphertext. On one case, it checks the validity of the tag tag against c, by checking whether Σ_{id∈U}PRG(g_{id}²(0)∥2=tag·s₃+c mod p holds. On another case, it verifies the validity of [symbol] against ĉ by checking whether Σ_{id∈U\} [symbol] PRG(g_{id}²(0)∥2= [symbol] . s₃+ĉ mod p holds, and whether the proof [symbol] is verified. If the aggregate ciphertext is correct, the client decrypts the ciphertext c or ĉ.

It is additionally distributed the secret s₃ for HMAC generation in the setup phase. Then, each client uses the secret to compute the corresponding HMAC-based tag for its cipher text. With all HMAC-based tags from clients, the server aggregates the tags. After the aggregate tag and the aggregate cipher text are returned to the clients, they verify the validity of the aggregate cipher text. If the verification is successful, a sufficient number of clients collaborate to decrypt the aggregate cipher text.

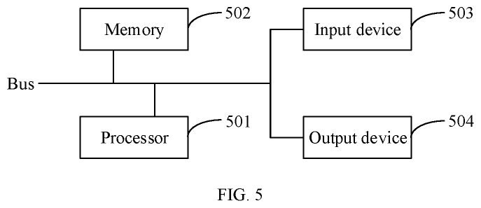

In addition, an image processing device is provided in an embodiment of the present disclosure. As shown in FIG. 5, the image processing device may include: a processor 501, a memory 502, an input device 503 and an output device 504.

The image processing device may include one or more processors 501, and one processor is shown in FIG. 5 as an example. In some embodiments of the present invention, the processor 501, the memory 502, the input device 503 and the output device 504 may be connected by a bus or in other ways. The connection via a bus is taken as an example in FIG. 5.

The memory 502 may be used to store software programs and modules, and the processor 501 executes various functional applications and data processing of the image processing device by running software programs and modules stored in the memory 502. The memory 502 may mainly include a program storage area and a data storage area. The program storage area may store an operating system, an application program required for at least one function, and the like. Additionally, the memory 502 may include a high-speed random access memory, and may also include a non-volatile memory, such as at least one magnetic disk storage device, flash memory device, or other volatile solid state storage device. The input device 503 may be used to receive input numerical or character information, and generate signal input related to user settings and function control of the image processing device.

Specifically in this embodiment, the processor 501 loads the executable files corresponding to the processes of one or more application programs into the memory 502 according to the following instructions, and the processor 501 executes the application programs stored in the memory 502, thus to realize various functions of the image processing device.

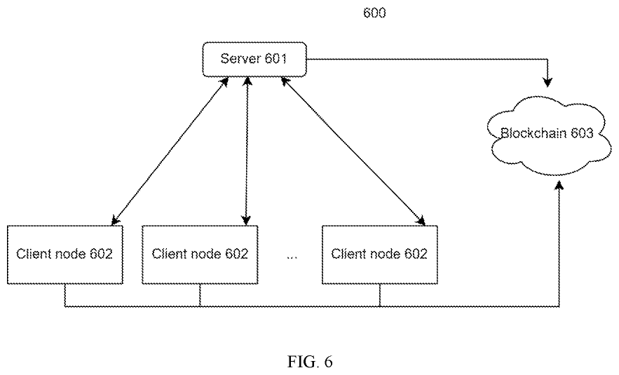

In addition, a system for building blockchain-based secure aggregation in federated learning with data removal is provided according to an embodiment of the present disclosure. As shown in FIG. 6, the system 600 includes a server 601, multiple client nodes 602, and a blockchain 603 in communication. The server 601 can execute the foregoing steps as described in connection with FIGS. 2a and 2b. The client node 602 can execute the foregoing steps as described in connection with FIGS. 3a and 3b. The system 600 is applicable for executing any of the methods or protocols or enhanced protocols as described herein.

It should be noted that, in this document, relational terms such as “first” and “second” etc. are only used to distinguish one entity or operation from another entity or operation, and do not necessarily require or imply there is such actual relationship or sequence between these entities or operations. Moreover, the terms “comprising”, “comprises” or any other variation thereof are intended to encompass a non-exclusive inclusion such that a process, method, article or device that includes a list of elements includes not only those elements, but also includes other elements not explicitly listed, or elements inherent to such a process, method, article or apparatus. Without further limitation, an element defined by the phrase “comprising a . . . ” does not preclude the presence of additional identical elements in a process, method, article or apparatus that includes the element.

The above embodiment is a preferred embodiment of the invention, which is not intended to limit the scope of the present invention. Any changes, modifications, substitutions, combinations, simplifications without departing from the spirit and principle of the invention shall fall within the scope of the invention.

What is claimed is:

1. A method for building blockchain-based secure aggregation in federated learning with data removal, applied by a server in a system for building blockchain-based secure aggregation in federated learning with data removal, comprising:
selecting, from a plurality of client nodes each being provided with a unique identifier id in the system, a first quantity of client nodes, to participate in an i-th iteration of the federated learning, where i is an integer;
sending a list of the selected client nodes to each of the first quantity of client nodes;
acquiring model training information transmitted by each of a second quantity of client nodes among the first quantity of client nodes, the model training information being transmitted in a form of cypher text, and being obtained by the client nodes through training local models with local training data, wherein the cypher text is generated by performing homomorphic encryption on the model training information based on pairwise seeds computed for each of the first quantity of client nodes from a symmetric bivariate polynomial and a private seed computed from asymmetric bivariate polynomial;
aggregating the cypher text of the model training information to obtain an aggregate result; and
broadcasting a list of the second quantity of client nodes and the aggregate result via a blockchain.

2. The method according to claim 1, further comprising:
for a (i+1)-th iteration, sending a list of a third quantity of client nodes together with an aggregate result of model training information previously transmitted from the second quantity of client nodes, to each of the third quantity of client nodes, for allowing the third quantity of client nodes to reconstruct local models to be used in the (i+1)-th iteration, wherein the third quantity of client nodes are a subset of the second quantity of client nodes.

3. The method according to claim 1, wherein the symmetric bivariate polynomial denoted by F(x, y) and the asymmetric bivariate polynomial denoted by G(x, y) are selected and sent to the client nodes by a one-time dealer in an initialization process.

4. The method according to claim 3, wherein for any client node id, the pairwise seed computed for another client node with identifier id′ from the symmetric bivariate polynomial is f_{id}¹(id′)=F(id, id′), where F(id, id′)=F(id′, id).

5. The method according to claim 4, wherein the cypher text c_{id} generated by the client node id is generated by:
$${c}_{id} ← {x}_{id} + {\sum }_{id ′ ∈ {U}_{1} \backslash id} Δ \cdot PRG ( {f}_{id}^{1} ( {id}^{′} ) ) + PRG ( {g}_{id}^{2} ( 0 ) ‖ 1 ) ( mod p )$$
$$where$$
$$Δ = \{ \begin{matrix}1 if id < {id}^{′} \\ - 1 if id > {id}^{′}\end{matrix}$$
wherein x_{id} represents the model training information obtained by the client node id, U₁ represents a set of identities of the first quantity of client nodes, PRG represents a Pseudo-Random Generator, g_{id}²(0) represents the private seed computed from the asymmetric bivariate polynomial G(0, id), p represents a roughly λ-bit prime, and λ is a security parameter.

6. The method according to claim 1, further comprising:
acquiring the cipher text cid and a tag tagid transmitted by each of the second quantity of client nodes, wherein the cipher text cid and the tag tagid are computed by MaskAndMAC(pp, sk, id, xid)→(cid, tagid), wherein pp represents a public parameter component available to the server and the client nodes, sk represents secret key secretly shared among the client nodes, and xid represents the model training information of the client node id;
aggregating respective tags into an aggregate tag; and
broadcasting the aggregate tag associated with the aggregate result via the blockchain.

7. A method for building blockchain-based secure aggregation in federated learning with data removal, applied by a first client node in a system for building blockchain-based secure aggregation in federated learning with data removal, comprising:
receiving, from a server in the system, a list of selected client nodes, wherein the selected client nodes are in a first quantity and are selected to participate in an i-th iteration of the federated learning by the server from a plurality of client nodes in the system, each of the selected client nodes is provided with a unique identifier id, and the first client node is one of the first quantity of the selected client nodes, i is an integer;
acquiring model training information by training a local model with local training data;
generating cypher text of the model training information by performing homomorphic encryption on the model training information based on pairwise seeds computed for each of the first quantity of client nodes from a symmetric bivariate polynomial and a private seed computed from asymmetric bivariate polynomial; and
sending the cypher text of the model training information to the server.

8. The method according to claim 7, wherein the symmetric bivariate polynomial F(x, y) and the asymmetric bivariate polynomial G(x, y) are selected and sent to the client nodes by a one-time dealer in an initialization process.

9. The method according to claim 8, further comprising:
computing, for the identifier id of the first client node, the cipher text cid and a tag tagid by MaskAndMAC(pp, sk, id, xid)→(cid, tagid), wherein pp represents a public parameter component available to the server and the client nodes, sk represents secret key secretly shared among the client nodes, and xid represents the model training information of the first client node id;
sending the cipher text cid and the tag tagid to the server.

10. The method according to claim 8, wherein for the first client node id, the pairwise seed computed for another client node with identifier id′ from the symmetric bivariate polynomial is f_{id}¹(id′)=F(id, id′), where F(id, id′)=F(id′, id).

11. The method according to claim 10, wherein the cypher text c_{id} generated by the client node id is generated by:
$${c}_{id} ← {x}_{id} + {\sum }_{id ′ ∈ {U}_{1} \backslash id} Δ \cdot PRG ( {f}_{id}^{1} ( {id}^{′} ) ) + PRG ( {g}_{id}^{2} ( 0 ) ‖ 1 ) ( mod p )$$
$$where$$
$$Δ = \{ \begin{matrix}1 if id < {id}^{′} \\ - 1 if id > {id}^{′}\end{matrix}$$
wherein x_{id} represents the model training information obtained by the client node id, U₁ represents a set of identities of the first quantity of client nodes, PRG represents a Pseudo-Random Generator, g_{id}²(0) represents the private seed computed from the asymmetric bivariate polynomial G(0, id), p represents a roughly λ-bit prime, and λ is a security parameter.

12. The method according to claim 8, further comprising,
for an (i+1)-th iteration:
acquiring, from the server, a list of a third quantity of client nodes together with an aggregate result of model training information previously transmitted from the second quantity of client nodes; and
reconstructing a local model to be used in the (i+1)-th iteration by using the list of the third quantity of client nodes together with the aggregate result of model training information previously transmitted from the second quantity of client nodes.

13. The method according to claim 12, wherein the reconstructing the local model to be used in the (i+1)-th iteration comprises:
computing private seeds (g_{id}¹(id′), g_{id}²(id′)), for each of the third quantity of client nodes, which is of identifier id′, wherein g_{id}¹(id′)=G(id, id′), g_{id}²(id′)=G(id′, id), id′∈U₃\id, U₃ represents a set of the identifiers of the third quantity of client nodes;
transmitting Lagrange Components of shares {g_{id′}²(id)·L_{id′}}_{id′∈U}_{₂} for recovering each g_{id′}²(0) and corresponding shares for {f_{id′}²(id″)}_{id″∈U}_{₂}_{\U}_{₃}_{∧id″∈U}_{₁}_{\U}_{₂} via one-time encryption with previous pairwise shared keys, wherein L_{id′} represents Lagrange Component, U₁ represents a set of the identifiers of the first quantity of client nodes, and U₂ represents a set of the identifiers of the second quantity of client nodes;
reconstructing the local model using the shares above from id′∈U₃.

14. The method according to claim 8, further comprising:
acquiring, from the block-chain, an aggregate tag associated with the aggregate result of model training information previously transmitted from the third quantity of client nodes, and
before reconstructing the local model, verifying correctness of the aggregate result by checking validity of the aggregate tag against the aggregate result,
wherein the aggregate tag is aggregated by the server from tags of the client nodes.

15. A server comprising a processor configured to implement the method according to claim 1.

16. A client device comprising a processor configured to implement the method according to claim 7.

17. A system for building blockchain-based secure aggregation in federated learning with data removal, comprising a server, a plurality of client nodes, and a block chain, wherein:
the server is configured for:
selecting, from the plurality of client nodes each being provided with a unique identifier id in the system, a first quantity of client nodes, to participate in an i-th iteration of the federated learning, where i is an integer;
sending a list of the selected client nodes to each of the first quantity of client nodes;
acquiring model training information transmitted by each of a second quantity of client nodes among the first quantity of client nodes, the model training information being transmitted in a form of cypher text;
aggregating the cypher text of the model training information to obtain an aggregate result; and
broadcasting a list of the second quantity of client nodes and the aggregate result via the blockchain; and
each of the plurality of client nodes is configured for:
receiving, from a server in the system, the list of selected first quantity client nodes;
acquiring model training information by training a local model with local training data;
generating cypher text of the model training information by performing homomorphic encryption on the model training information based on pairwise seeds computed for each of the first quantity of client nodes from a symmetric bivariate polynomial and a private seed computed from asymmetric bivariate polynomial; and
sending the cypher text of the model training information to the server.

18. The system according to claim 17, wherein the symmetric bivariate polynomial is F(x, y) and the asymmetric bivariate polynomial is G(x, y), the pairwise seed computed for another client node with identifier id′ from the symmetric bivariate polynomial is f_{id}¹(id′)=F(id, id′), where F(id, id′)=F(id′, id), the cypher text c_{id} generated by the client node id is generated by:
$${c}_{id} ← {x}_{id} + {\sum }_{id ′ ∈ {U}_{1} \backslash id} Δ \cdot PRG ( {f}_{id}^{1} ( {id}^{′} ) ) + PRG ( {g}_{id}^{2} ( 0 ) ‖ 1 ) ( mod p )$$
$$where$$
$$Δ = \{ \begin{matrix}1 if id < {id}^{′} \\ - 1 if id > {id}^{′}\end{matrix}$$
wherein x_{id} represents the model training information obtained by the client node id, U₁ represents a set of identities of the first quantity of client nodes, PRG represents a Pseudo-Random Generator, g_{id}²(0) represents the private seed computed from the asymmetric bivariate polynomial G(0, id), p represents a roughly λ-bit prime, and λ is a security parameter.
